(19) United States
(12) Patent Application Publication
(10) Pub. No.: US 2003/0115343 A1
(43) Pub. Date: Jun. 19, 2003

(54) Unwanted routing block

(76) Inventor: Thomas R. Mosey, Mystic, CT (US)

Correspondence Address: Rodolf O. Siegesmund, Suite 2000, 4627 N. Central Expressway, Dallas, TX, 75205-4017, US

(21) Appl. No.: 10/023,170

(22) Filed: Dec. 17, 2001

(51) Int. Cl. G06F 15/16

(52) U.S. Cl. 709/229; 709/217

(57) ABSTRACT

The present invention, which meets the needs identified above, is an apparatus and method for immediately identifying an invalid URL and providing a user the option of refusing or allowing an alternative URL. If the user decides to accept the alternative URL, the program will direct the user to the alternative URL and proved the user with the option of iterating or ending the program. If the user decides to refuse the alternative URL, then the program will provide the user the option of entering a different URL. The user may enter a new URL, in which case the program iterates and determines whether the new URL is valid, or the user may decline and end the program.

### FIELD OF INVENTION

The present invention relates to an apparatus and method for identifying an invalid URL address and preventing the user from being directed to an alternative site by the browser.

### BACKGROUND

The internet is a global computer network providing access to a large body of information. The World Wide Web (WWW or web) is a conglomerate of interlinked hypertext documents and files residing on Hypertext Transfer Protocol (HTTP) servers around the world. The Uniform Resource Locator (URL) of a file is its address and specifies the protocol to be used to access the file (http: for the web), the host containing the server (www), the domain name of the server where the file resides, and the particular file to be accessed. Files on the web, called web pages or web sites, are written in Hypertext Markup Language (HTML), located by their URL, and transmitted from the server to the user under HTTP. A web browser is a software program that lets a user view HTML documents and access files and software related to the documents. Web browsers can also provide access to documents on a network, the internet, or a local hard drive.

The collection of information on the web is not organized or indexed, making the task of locating useful information difficult. When a URL is entered by a user, the user is directed to the appropriate web site. However, if the user enters an invalid URL or makes a mistake in entering the URL, the browser may direct the user to an alternate web site. The user may desire to avoid being directed to alternative sites and may only want to know whether the original URL is incorrect. Therefore, a need exists for a program that can be built into a web browser or installed on a computer that will prevent the user from being sent to an alternative web site when the user enters an invalid URL.

### SUMMARY OF INVENTION

The present invention, which meets the needs identified above, is an apparatus and method for identifying an invalid URL and providing the user with the option of refusing or allowing an alternative URL. If the user decides to accept the alternative URL, the program will direct the user to the alternative URL and provide the user with the option of ending or iterating the program. If the user decides to refuse the alternative URL, then the program will provide the user the option of entering a different URL. The user may decline and end the program or the user may enter a new URL, in which case the program iterates and determines whether the new URL is valid.

The foregoing and other objects, features, and advantages of the invention will be apparent from the following more particular description of the preferred embodiment of the invention, as illustrated in the accompanying drawings wherein like reference numbers represent like parts of the invention.

### BRIEF DESCRICPTION OF DRAWINGS

FIG. 1 depicts a computer network over which the process may be implemented.

FIG. 2 depicts hardware capable of implementing the invention.

FIG. 3 depicts the flowchart of the Unwanted Routing Block

### DESCIPTION OF PREFERRED EMBODIMENTS

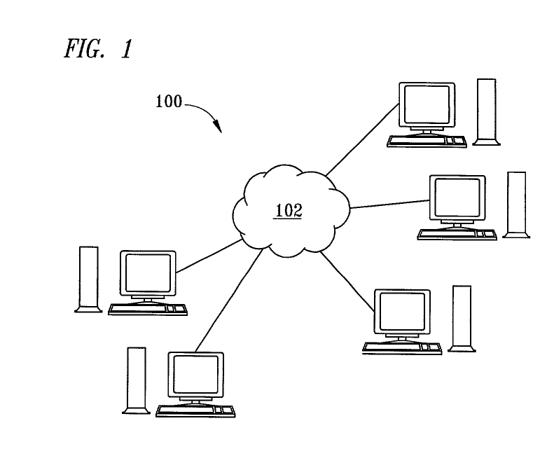

FIG. 1 depicts a pictorial representation of a distributed data processing system in which Unwanted Routing Block 300 may be implemented and is intended as an example and not as an architectural limitation for the processes of Unwanted Routing Block 300. Distributed data processing system 100 is a network of computers containing network 102, which communicates with devices and computers connected together within distributed data processing system 100. Network 102 may include permanent connections, such as wire or fiber optic cables, or temporary connections made through telephone connections, personal computers, or network computers. Distributed data processing system 100 may include additional servers, clients, and other devices not shown. In the depicted example, distributed data processing system 100 is the internet with network 102 representing the worldwide collection of networks and gateways that use the TCP/IP suite of protocols to communicate with one another. Distributed data processing system 100 may also be implemented as a number of different types of networks, such as and intranet, a local area network (LAN), or a wide area network (WAN).

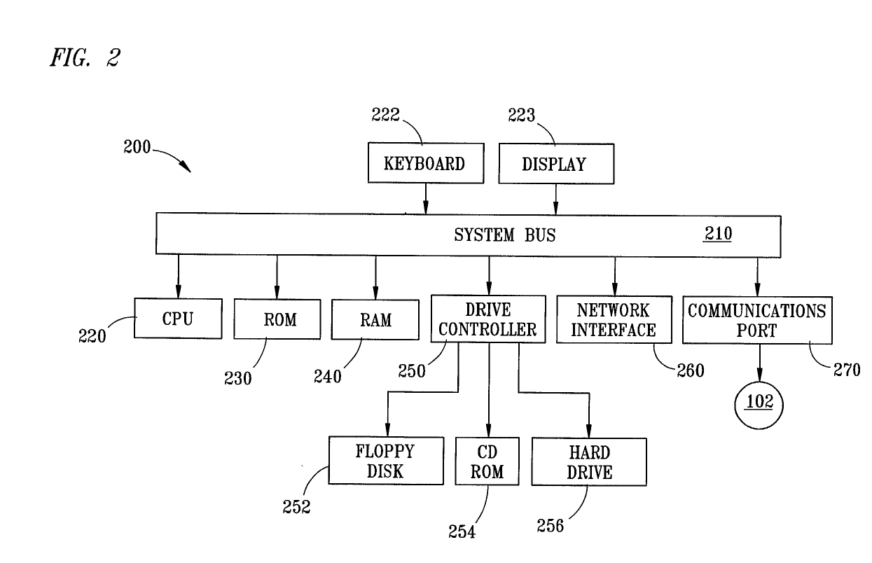

FIG. 2 depicts computer 200. Although the depicted embodiment involves a personal computer, Unwanted Routing Block 300 may be implemented in other types of data processing systems. An exemplary hardware arrangement for computer 200 follows. Keyboard 222 and display 223 are connected to system bus 210. Read Only Memory (ROM) 230 contains boot strap routines and a Basic Input/Output System (BIOS) utilized to initiate Central Processing Unit (CPU) 220 at startup. Random Access Memory (RAM) 240 represents the main memory utilized for processing data. Drive controller 250 interfaces one or more disk drives such as floppy disk drive 252, CD ROM 254, and hard disk drive 256. The number and type of drives utilized with a particular system will vary depending upon the user requirements and should be determined by those skilled in the art. Network interface 260 permits communications to be sent and received from network 102. Communications port 270 may be utilized for a dialup connection to one or more networks 102 while network interface 260 is a dedicated interface to a particular network. Programs for controlling the apparatus shown in FIG. 2 are typically stored on a disk drive and then loaded into RAM 240 for execution during start-up of the computer.

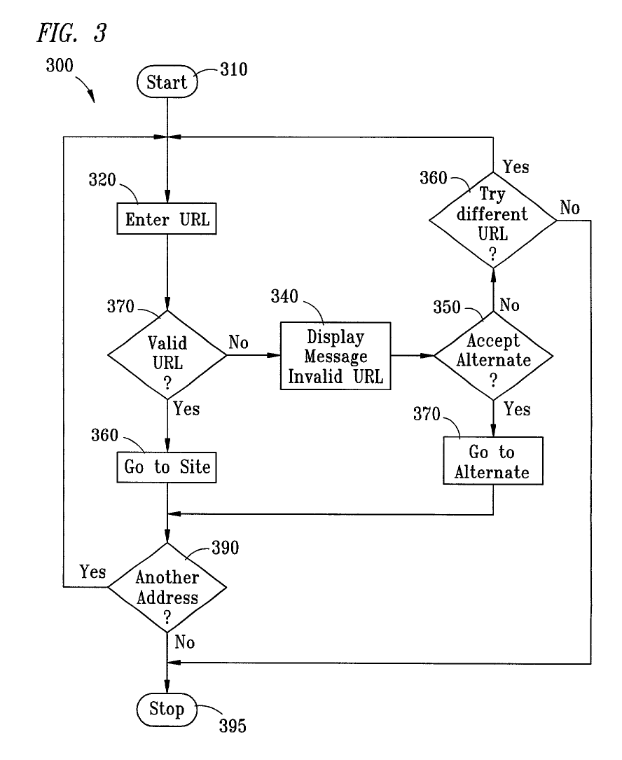

FIG. 3 depicts a flow diagram of Unwanted Routing Block 300. The method depicted may be incorporated in a program installed on the computer directly, downloaded from the internet as a plug-in, or may be installed on the web browser software at the time of manufacture. The program begins 310 whenever a new URL is entered by the user in the browser request window 310. Upon accepting a URL 320, Unwanted Routing Block 300 determines whether or not a web site exists for the URL requested 330. If an exact match does not exist, a message is displayed informing the user that the URL entered is invalid 340. The user is then presented with the option of being directed to an alternative web site 350. If the user chooses not to be directed to an alternative web site, then the user is given the option of entering a new URL or ending the program 360. If the user decides to try a different URL, Unwanted Routing Block 300 and begins again with the entry of a new URL at step 320. If the user does not want to try a different URL, the program will end 395. If at step 350, the user decides to accept the alternative web site, then the user will be directed to the alternative web site 370. The program will then present the user with the option of entering another URL 390. If the user enters another URL, the program will go to step 320 and the program iterates. If the user does not enter another URL, the program will end 395.

If at step 330, the user's URL matches the desired web site's URL, then the user will be directed to the web site 380. When the user is finished at the web site, then the user will be presented with the option at step 390.

It will be understood from the foregoing that various modifications and changes may be made in the preferred embodiment of the present invention by those skilled in the art without departing from its true spirit. It is intended that this description is for purposes of illustration only and should not be construed in a limiting sense. The scope of the invention should be limited only by the language of the following claims.

What is claimed is:

1. A method for providing user control over alternative URL direction using a computer having an installed web browser and a block program comprising the steps of:
entering a URL;
determining whether there is an exact match for the URL;
responsive to a determination that there is not an exact match for the URL, displaying an invalid URL message and querying the user as to whether the user will accept an alternative URL; and
responsive to a determination that the user will accept the alternate URL, sending the user to the alternative URL.

2. The method in claim 1 further comprising, responsive to a determination that the user will not accept the alternative URL, determining whether the user will try a different URL; and responsive to a determination that the user will try the different URL, entering the different URL.

3. The method in claim 1 further comprising presenting the user with the option of entering another URL after the user has finished with the original URL, and responsive to a determination that the user will try another URL, entering another URL.

4. The method in claim 1 further comprising presenting the user with the option of entering another URL after the user has finished with the alternative URL, and responsive to a determination that the user will try another URL, entering another URL.

5. A computer implemented process to accomplish searching the internet for a smart domain site comprising:
using a first computer, performing the following series of steps:
powering the first computer;
accessing the internet with the computer;
communicating a URL request in a browser installed on the first computer;
determining if there is an exact match for the URL; and
responsive to a determination that there is not an exact match, displaying the invalid URL message and determining whether the user will accept an alternative site.

6. A computer readable memory for causing a computer to perform an unwanted reading block comprising:
a computer readable storage medium;
a computer program stored in the storage medium; and
the storage medium, so configured by the computer program, causes the computer to display an invalid URL message whenever the URL does not exactly match the desired URL.
